(19) United States
(12) Patent Application Publication
(10) Pub. No.: US 2016/0100197 A1
(43) Pub. Date: Apr. 7, 2016

(54) Method and System for Generating a Video Synopsis from Compressed Video Images

(71) Applicant: GORILLA TECHNOLOGY INC., TAIPEI (TW)

(72) Inventors: Sze-Yao Ni, Taipei (TW); Tom C.-I. Lin, Taipei (TW)

(21) Appl. No.: 14/864,916

(22) Filed: Sep. 25, 2015

(30) Foreign Application Priority Data
Oct. 1, 2014 (TW) 103134319

(51) Int. Cl. H04N 19/85; H04N 19/46; H04N 19/44

(52) U.S. Cl. CPC H04N 19/85; H04N 19/44; H04N 19/46

(57) ABSTRACT

A method and system for generating a video synopsis from compressed video images is disclosed, wherein the compressed video images are generated by dividing each image of the original video into a plurality of macroblocks, wherein each of the macroblocks has the same macroblock size. By analyzing and utilizing characteristics of video compression information to determine the importance of each of the macroblocks, the distribution of the important macroblocks in time and space can be obtained, and a video synopsis of a specified length can be synthesized by arranging the important macroblocks in a particular temporal and spatial order.

### CROSS-REFERENCE TO RELATED APPLICATION

This application claims the Priority of Taiwan application No. 103134319 filed Oct. 1, 2014, the disclosure of which is incorporated herein in its entirety by reference.

### BACKGROUND OF THE INVENTION

1. Field of the Invention

The present invention is related to a method and system for generating a video summary, in particular, related to a method and system for generating a video summary from a fixed surveillance video.

2. Description of the Prior Art

Usually, when reviewing a surveillance video, the surveillance video is played in a fast mode manually for quickly reviewing relevant contents in the surveillance video; however, it is time-consuming and takes a lot of manpower to do that. Therefore, a new way to review a surveillance video in a fast and effective way so as to obtain the desired portions of the images in the surveillance video is desired for a surveillance video player.

Conventionally, methods, such as video abstract, video summary as well as video indexing, provide a quick search of each important image information in the surveillance video, such as images containing people or objects in the surveillance video. By doing so, a lengthy surveillance video can be concentrated to a small number of images, and then the interested portions of the images can be selected by a video inspector for further inspection so as to obtain the desired portions of the images from the surveillance video.

In video synopsis methods, such as the method and system for video indexing and video synopsis disclosed in U.S. Pat. No. 8,514,248 and the method and system for producing a video synopsis disclosed in patent US20130027551, firstly, the background image sequence and foreground object sequence are obtained through image analysis method, and then the presence time of each foreground object can be obtained according to the positions of the foreground object relative to the background image. Finally, the background image sequence and image sequence of objects or events arranged in a particular temporal order are synthesized through image superimposition. However, it takes a huge amount of computing time to obtain the background image and foreground object image sequences by using such a method in order to produce a summary image sequence. In addition, subject to the limitation of current image analysis method, it is not guaranteed that the objects can be extracted from the foreground object sequences completely and even worse, some foreground information may get lost. Consequently, the complete information of the objects in the entire video cannot be presented for viewing.

Therefore, the present invention propose a new method and system for producing a video synopsis to overcome the above-mentioned problems.

### SUMMARY OF THE INVENTION

Due to the fact that viewing an original lengthy video is very time consuming, a new way to quickly identify the important video segments for a user to inspect is necessary and desired. In a generic video playback system, the system will often provide a sequence of images to allow the user to choose the video segments of interest. These images are often sampled with fixed time intervals to allow the user to quickly select the video segments he/she wishes to view. The system could further use a key frame extractor to select a sequence of meaningful and important images so as to allow the user to choose an interested portion of the images for viewing. However, the information provided by an individual image is often not enough for an observer to understand the events conducted by objects from the extracted images and as a result, the observer will often need to review the original video sequence to verify the actual events. As such, a way to filter out meaningless images not containing foreground objects and at the same time organize the foreground objects to generate a video synopsis of a lengthy and tedious surveillance video is of great importance.

Through video analysis methods, the images are classified as a background image sequence and a foreground object sequence, wherein the background image sequence contains no objects and the foreground object sequence is formed by extracting all of the objects appearing in the scene. Then, the background image sequence and serval foreground object sequences are overlapped to create a video synopsis that has a much shorter length than the original video. The user can then understand what is happening in the video by viewing the video synopsis. In addition, subject to the limitation of current image analysis method, it is not guaranteed that the objects can be extracted from the foreground object sequences completely and the object produced in this way may have a broken edge as well, and even worse, some foreground information may get lost. Consequently, the complete information of the objects in the entire video cannot be presented for viewing.

One objective of the present application is to provide a fast way with lower computing complexity to analyze the importance of the images so as to allow a user to quickly select video segments that needs to be viewed in detail.

The present invention proposes a method and system to generate a video synopsis of a compressed video, wherein said compressed video is formed by compressing a plurality of macroblocks in each image of the original video, wherein each of the plurality of macroblocks has a predetermined macroblock size. By analyzing the video bit-stream of the surveillance video, important macroblocks can be identified. The images in the video are then classified as important images or unimportant images based on the distribution of the important macroblocks, or in other words, meaningful and meaningless images. By analyzing the distribution of important images, the meaningful video segments can be identified to drastically shorten the length of the video. Image synthesizing technology can then be used to determine the overlapping relationship of the video segments according to the distribution of important macroblocks in the important video segments, so as to overlap and synthesize several video segments into a video synopsis.

In one embodiment, a system for generating video synopsis from a compressed video is disclosed, the system comprising: a decoder unit for decoding a compressed video to extract decompressed images, wherein the compressed video is formed by compressing a plurality of macroblocks in each image of the original video, each of the plurality of macroblocks has a predetermined macroblock size; an important macroblock analysis unit for analyzing the encoding information of the compressed video so as to determine if each of the plurality of macroblocks in each image is an important macroblock; and a video synopsis synthesizing unit for generating a video synopsis by synthesizing the important macroblocks of the images according to the distribution of the important macroblocks in each image.

In one embodiment, the decoder unit is used for analyzing video bit streams to obtain video content so as to further obtain special video compression information thereof for the important macroblock analysis unit to determine if each of the macroblocks in each of the images is an important macroblock, wherein said special video compression information includes at least one of the following: the number of encoded bits used, motion vectors, encoding types and DCT coefficients.

In one embodiment, the system further comprises an image data storage unit for storing the images and video compression information obtained from the decoder unit so as to provide the system required encoding information for decompressing the compressed video in a non real-time video synopsis application.

In one embodiment, a method for generating video synopsis from a compressed video is disclosed, the method comprising the steps of: decoding a compressed video to extract decompressed images, wherein the compressed video is formed by compressing a plurality of macroblocks in each image of the original video, each of the plurality of macroblocks has a predetermined macroblock size; analyzing the encoding information in the compressed video so as to determine if each of the plurality of macroblocks in each of the images is an important macroblock; and generating a video synopsis by synthesizing the important macroblocks in the images according to the distribution of important macroblocks in each image.

In one embodiment, the method determines whether if each of the macroblocks in each of the images is an important macroblock according to the encoding information of each macroblock, wherein said encoding information includes at least one of the following: the number of encoded bits used, motion vectors, encoding types and DCT coefficients.

In one embodiment, the method determines whether if an image is an important image according to the distribution of important macroblocks in said image.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 illustrates a schematic of a system for generating a video synopsis from a surveillance video;

FIG. 2 illustrates a schematic of a method for synthesizing images for generating a video synopsis;

FIG. 3 illustrates a schematic showing the results of synthesized images;

FIG. 4 illustrates a schematic of a method for generating a video synopsis from a surveillance video;

FIG. 5 illustrates a schematic of a non real-time synthesizing system for generating a video synopsis from a surveillance video;

FIG. 6a illustrates a schematic of the distribution of important macroblocks in a non real-time synthesizing system; and

FIG. 6b illustrates a schematic of temporal relationships in the video synopsis.

### DESCRIPTION OF THE PREFERRED EMBODIMENT

The detailed explanation of the present invention is described as following. The described preferred embodiments are presented for purposes of illustrations and description, and they are not intended to limit the scope of the present invention.

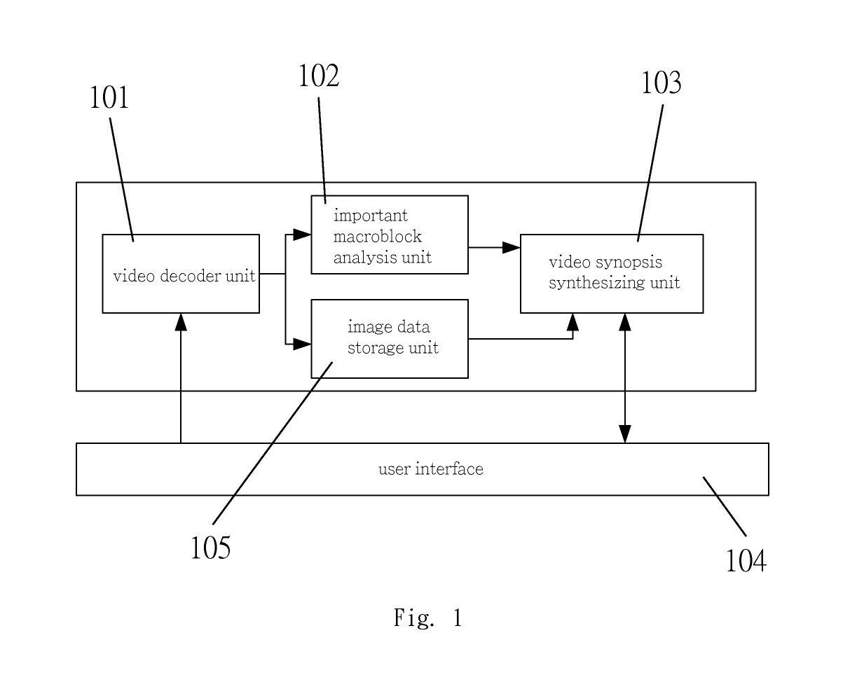

Please refer to FIG. 1 which illustrates a schematic of a system for generating a video summary from a surveillance video, the system comprising a video decoder unit 101 for analyzing a compressed video designated by a user interface 104, extracting the decompressed video information and sending said decompressed video information to the important macroblock analysis unit 102 and the image data storage unit 105, wherein the compression of said compressed video comprises dividing each image of the original video into a plurality of macroblocks according to a compression macroblock size; an image data storage unit 105 for storing decompressed video information provided by the video decoder unit 101 and providing the video synopsis synthesizing unit with the required video information; an important macroblock analysis unit 102 for analyzing the encoding data of the compressed video so as to determine if each of the plurality of macroblocks in each image is an important macroblock, obtain the distribution of the important macroblocks, and send said distribution of important macroblocks to the video synopsis synthesizing unit 103; a video synopsis synthesizing unit 103 for receiving information from the image data storage unit 105 and the important macroblock analysis unit 102 to synthesize a video synopsis and provide said video synopsis to the user interface 104; and the user interface 104 to allow the user to provide the decoder unit with a compressed video and to display the video synopsis resulting from the video synopsis synthesizing unit 103.

In a preferred embodiment, the video decoder unit 101 is used for analyzing video bit streams to obtain video content so as to further obtain specific video compression information thereof for the important macroblock analysis unit 102 and image data for the image data storage unit 105, wherein said special video compression information can be one of or in any combination of compression information, such as the number of encoded bits used, motion vectors, encoding types or DCT coefficients. In another embodiment, both the specific video compression information and the image data from the video decoder unit 101 are sent to the image data storage unit 105 for subsequent use in further applications.

In a preferred embodiment, the image data storage unit 105 can be used to store the video information provided by the decoder unit 101 and provide the video synopsis synthesizing unit 103 the required video information. The image data storage unit 105 can be further used to store the images and encoding information outputted from the decoder unit 101 so as to provide the system with required encoding information for decompressing the compressed video in a non real-time video synopsis application.

In a preferred embodiment, the important macroblock analysis unit 102 can be used to receive video information from the decoder unit 101 and analyze the encoding information, mainly determining the importance of each macroblock according to the encoding information of each macroblock, wherein the encoding information of each macroblock can be one of or in any combination of compression information, such as the number of encoded bits used, motion vectors, encoding types or DCT coefficients, so as to extract all important macroblocks according to spatial locations and temporal orders of the important macroblocks. In addition, the importance of an image can be determined according to the distribution of important macroblocks in the images, and further an image that has important macroblocks is defined as an important image. Lastly, the analysis results and the important macroblock information are sent to the video synopsis synthesizing unit 103.

In a preferred embodiment, the video synopsis synthesizing unit 103 is used to receive integrated important macroblock information from the important macroblock analysis unit 102 and user interaction information from the user interface 104 so as to synthesize a video synopsis according to the time interval specified by the user and the important macroblock information, wherein the results of the video synopsis are sent to a display device or stored to a storage device for subsequent inspection by the user.

In a preferred embodiment, the user interface 104 is used to allow the user to specify the original video he/she wishes to generate a video synopsis for and send said original video to the video decoder unit 101. The user interface 104 will then receive video synopsis results from the video synopsis synthesizing unit 103 and display said results on a display device. At the same time, the user interface 104 contains video synopsis parameters that can be set by the user, wherein the parameters include the length of the video synopsis, the overlapping threshold for important macroblocks and the location of particular macroblocks.

In a preferred embodiment, the important macroblock analysis unit 102 is mainly used for selecting important macroblocks in images. In a compressed video, image data originally appearing in previous images will be represented by minimal data while new image data not originally appearing in previous images will require more data to represent. In other words, we can view an important macroblock as a macroblock that requires more data to encode. Therefore, the importance of a macroblock is determined by encoding information of a macroblock, wherein the encoding information can be one of or in any combination of compression information, such as the number of encoded bits used, motion vectors, encoding types or DCT coefficients. A way of analyzing the importance of a macroblock can be expressed by:

ImpactMB_{i, j}=f(bit_{i, j}, mv_{i, j}, codingtype_{i, j}, DCTcoefficients_{i, j}), Wherein ImpactMBi, j is the importance of macroblock MBi, j; MBi, j is the macroblock located at position (i, j) in the image i ∈ [1, width]; j ∈ [1, height]; bit_{i, j} is the number of encoding bits, mv_{i, j} is the motion vector of MB_{i, j}; codingtype_{i, j} is the encoding type of MBi, j; and DCTcoefficients i, j is the encoding redundancy of MBi, j.

After the video data has been decoded and analyzed, the importance of each macroblock of each image can be obtained and through heuristic thresholding, the macroblocks can be classified as important or non-important. The distribution of important macroblocks can also be used in the classification of important images, the simplest way being classifying an image as an important image if said image contains important macroblocks and vice versa. The important macroblock information and important images are then sent to the video synthesizing unit 103 for synthesizing a video synopsis.

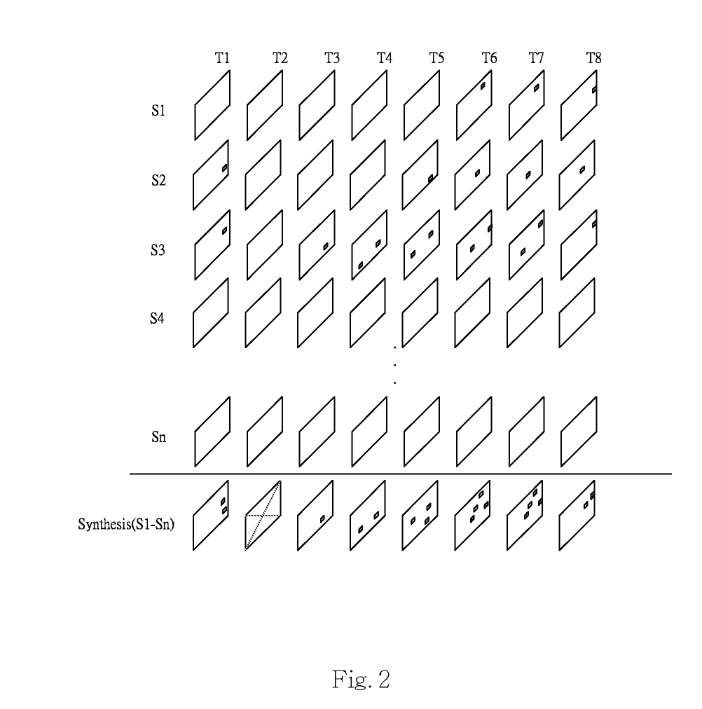

In another preferred embodiment, the video synthesizing unit 103 is mainly used for synthesizing all of the important macroblocks in a given time interval. First, the images not containing important macroblocks are filtered out according to the important macroblock information, while the remaining sequence of important images are synthesized according to the user defined needs. This method can synthesize a video synopsis according to the user-defined parameters and adaptive time-windows of temporal-spatial information of the image macroblocks. For example, if one wants to synthesize a 5 minutes video synopsis of a compressed video containing 100 minutes of video, the compressed video can be split into multiple intervals such as 20 intervals first, wherein the important macroblock information of each image in each interval is extracted. If there are no important macroblocks in a particular interval, the images in that particular interval will not be synthesized. On the other hand, if there are important macroblocks in an interval, the images in that interval will be synthesized based on the important macroblocks. For example, as shown in FIG. 2, in the time interval T2, there are no images that contain important macroblocks, the images in in the time interval T2 will not be synthesized, which is shown as the resulting image 202 containing no important macroblocks. This also means that the total amount of final synthesized images can be less than the total number of intervals. For other time intervals T1, T3, T4 . . . T8, each of them contains at least one image with important macroblocks, the images in each interval will be synthesized based on the corresponding important macroblocks in each interval, which are shown as the resulting images, 201, 203, 204 . . . 208, respectively.

The structure of the synthesized image will be in accordance with the distribution of the important macroblocks of the images in each interval. For example, in the time interval T1, S2 and S3 contain important macroblocks and therefore the image data corresponding to the location of the important macroblocks are extracted from S2 and S3. Image data in each of the remaining images, S1 and S4 to SN are averaged as the background images. If the important macroblocks overlap spatially, such as in time interval T8, the important macroblocks in S1 and S3 overlap spatially and therefore the final synthesized image data representing the overlapped important macroblocks will be the average of the image data in S1 and S3.

In another preferred embodiment, the length of the important video is first analyzed; if the unimportant video data is removed and the remaining video length is sufficient for the user's needs, no synthesizing is needed and the remaining video will be the video synopsis.

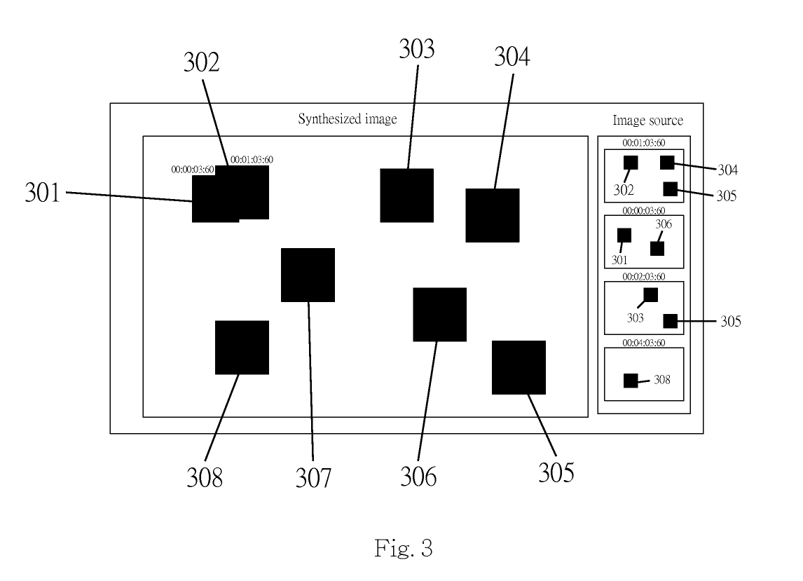

In another embodiment, the user interface 104 is provided for a user to select a video to generate a video synopsis or to view the result of the video synopsis. In one embodiment, the result of the video synopsis can be displayed on a main window and the original images of video that contains the important macroblocks for generating the video synopsis can be displayed on multiple sub-windows, wherein the sub-windows can further display the original images from which the overlapped important macroblocks are originated. In one embodiment, as shown in FIG. 3, the result of the video synopsis is shown on the main window. In addition, the original images from which important macroblocks were extracted to generate the video synopsis are show on the right, sorted by the number of important macroblocks. If there are overlapping important macroblocks, the macroblocks will be noted as overlapping macroblocks.

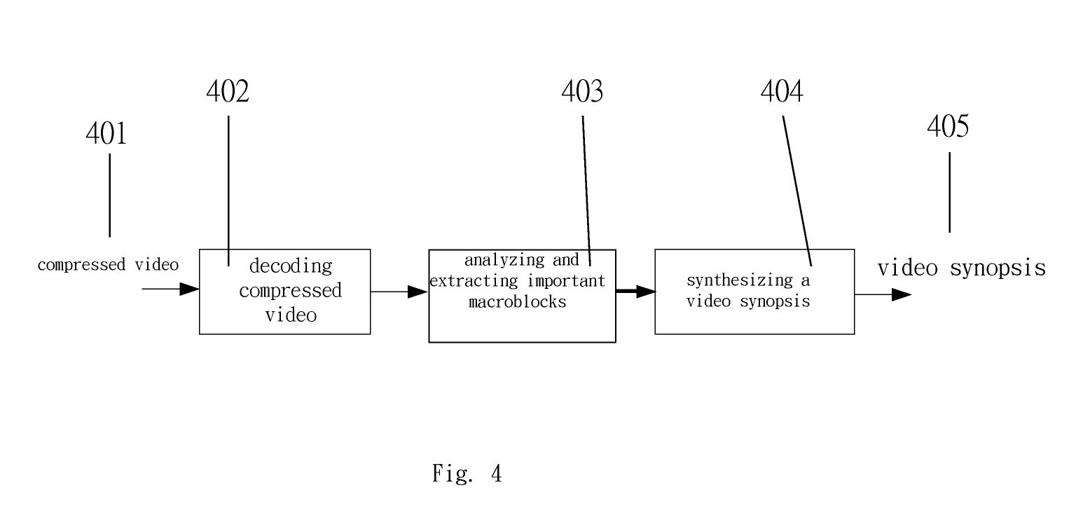

Please refer to FIG. 4 which illustrates the steps of generating a video synopsis from a compressed video 401. The steps comprise of decoding a compressed video 402, analyzing and extracting important macroblocks 403 and synthesizing a video synopsis 404, wherein the step 402 is for analyzing the video bit stream to obtain the encoding information which is provided for the step 403, the step 403 is for analyzing video encoding information to obtain distribution information of the important macroblocks in the images of the video for synthesizing a video synopsis, and the step 404 generates a video synopsis 405 according to the distribution of important macroblocks in each image.

The decoding process can be executed in a multi-threaded environment to allow the compressed video data to be decoded in parallel, while obtaining encoding information and image data at specific time intervals. Afterward, important macroblock analysis will be performed on the obtained information to extract important macroblocks. For example, when the video is divided into multiple intervals with each interval being equal to a specific time length, each interval must be one or more GOP units so as to allow each interval to be individually decoded. Afterward, multi-threaded decoding can be executed in each interval to obtain image data and video compression information. The obtained video compression information can be one of or in any combination of the following information: the number of encoded bits used, motion vectors, encoding type and DCT coefficients.

The important macroblock analysis will classify the macroblocks in each image as important macroblocks or unimportant macroblocks according to the encoding information in the obtained video compression information. In addition, the macroblocks will be analyzed according to the distribution of important macroblocks in an image and their temporal-spatial relationship to obtain the distribution of all the important macroblocks in the video. At the same time, each single image will be determined as an important image according to whether it contains an important macroblock.

Afterward, the video synopsis will be synthesized according to the important macroblock distribution. If the images in a particular timer interval are all unimportant images, then that particular time interval will be discarded and no synthesis will be performed for that particular time interval. In other words, images will be discarded based on their respective importance before synthesizing the video synopsis. If a time interval does contain an important image, then all of the unimportant macroblocks in that interval will be averaged, according to the spatial relationships between the unimportant macroblocks, to construct as scene image data; and the important macroblocks will be weighted according to the number of times it appears in a particular macroblock location and overlaid spatially to obtain an image synthesis. The rest of the video will be processed in the same manner to obtain the final video synopsis. When performing an image synthesis with constraints, such as a maximum overlapping ratio, the overlapping ratio will be calculated first, and if the overlapping ratio exceeds a maximum threshold, portions of the images will be delayed and the other portions of the images will be overlapped according to their respective weight.

To display the video synopsis and allow a user to control the video synopsis, a user interface unit is provided for a user to control and set user-defined parameters including constraints for synthesizing the video synopsis. In addition, when displaying the video synopsis, in order to avoid processing the same video data during rewinding, an image data storage unit can be used to temporarily store the processed information, such as image data or in combination with other related information, such as image macroblock encoding information, the number of encoding bits used for an image macroblock, motion vectors, encoding types and DCT coefficients.

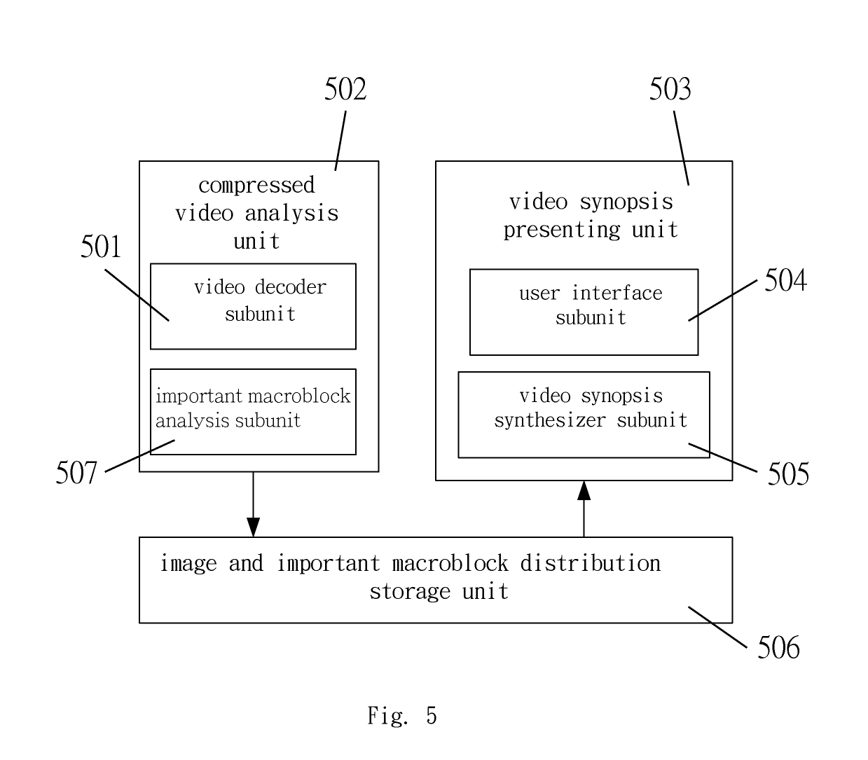

Please refer to FIG. 5 which illustrates a schematic of a non real-time synthesizing system for generating a video synopsis from a surveillance video. The video synopsis synthesis system comprises a compressed video analysis unit 502, an image and important macroblock distribution storage unit 506 and a video synopsis presenting unit 503. The compressed video analysis unit 502 comprises a video decoder subunit 501 and an important macroblock analysis subunit 507. The video decoder subunit 501 is used to analyze video bit streams to obtain the encoding information of the macroblocks of the images, number of encoded bits used, motion vectors, encoding types and/or DCT coefficients and decode the image sequences of the compressed video. The specific compressed video information is then sent to the important macroblock analysis subunit 507 and the compressed video data is sent to the image and important macroblock distribution storage unit 506 for subsequent use by other units. The important macroblock analysis unit 507 receives the video information from the video decoder subunit 501 so as to analyze the important of the macroblocks, and furthermore for using statistical methods according to the temporal relationship between the macroblocks to analyze the distribution of important macroblocks so as to determine the importance of the images. Finally, the analysis results and the statistical results are sent to the image and important macroblock distribution storage unit 506.

The video synopsis presenting unit 503 comprises a video synopsis synthesizer subunit 505 and a user interface subunit 504. The user can quickly browse through the available videos in a menu, and at the same time configure parameters related to the synthesizing of the video synopsis, such as the desired length of the video synopsis. At the same time, the user can view the video synopsis and other related surveillance information on the user interface subunit 504, wherein the video synopsis is generated by the video synopsis synthesizer subunit 505. The video synopsis synthesizer subunit 505 obtains the integrated important macroblock information and other related video image data from the image data and important macroblock distribution storage unit 506 to synthesize the video synopsis according to the user-defined parameters and sends the result of the video synopsis to the user interface subunit 504 for displaying on the display device or for storing on a storage device for subsequent use.

All surveillance videos can first be processed by the compressed video analysis unit 502 so as to obtain integrated important macroblock information and other related video image data which can be stored in the image and important macroblock distribution storage unit 506, wherein the saved data can be just simple time stamps and file offsets in order to save storage space. By doing so, the image data can be quickly retrieved when needed without having to decode the video again.

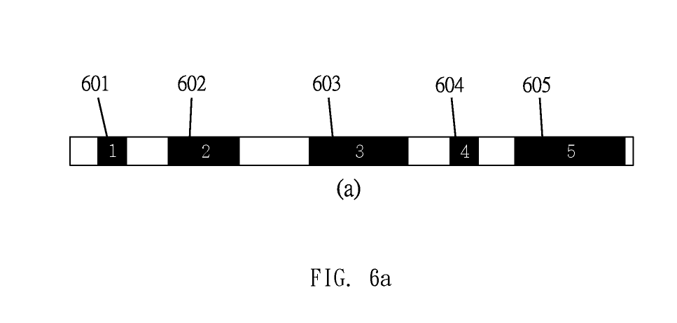

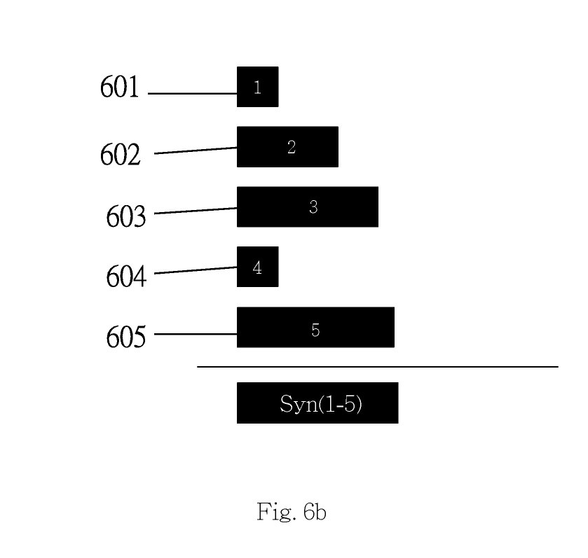

Please refer to FIG. 6a which illustrates a schematic of the distribution of important macroblocks in a non real-time synthesizing system, wherein the images containing important macroblocks are distributed in video segments 601, 602, 603, 604, and 605, wherein the images containing important macroblocks are defined as important images. The length of all the important images in each segment is analyzed, and the length of the longest video segment will be the length of the final video synopsis. In one embodiment, the method of synthesis comprises obtaining the macroblocks from all of the video segment with a same macroblock position wherein, if all of the macroblocks are unimportant, then the synthesized result for that macroblock will be the average of image data in all of the macroblocks; and if the macroblocks contain important macroblocks in a time interval, then the macroblocks are overlapped based on their respective weight to generate a synthesized macroblock image.

Please refer to FIG. 6b, for example, when synthesizing the fifth image, if a macroblock at image position (0, 0) of the fifth image in all the time intervals are unimportant macroblocks, then the pixels in the corresponding macroblock of the synthesized image will be the average of the pixels in each of the macroblocks at image position (0, 0) of the fifth image of all the time intervals. As shown in FIG. 6b, if each macroblock at image position (160, 160) of the fifth image in the time intervals 601, 603 and 605 is an important macroblock, then the pixels in the corresponding macroblock of the synthesized image will be the average of the pixels in each of the macroblocks at image position (160, 160) of the fifth image of the time interval 601, 603 and 605.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the claims appended hereto and their equivalents.

What is claimed is:

1. A system for generating a video synopsis from a compressed video, comprising:
a decoder unit, for decoding a compressed video to extract decompressed images, wherein the compressed video is formed by compressing a plurality of macroblocks in each image of the original video, wherein each of the plurality of macroblocks has a predetermined macroblock size;
an important macroblock analysis unit, for analyzing the encoding information of the compressed video so as to determine if each of the plurality of macroblocks in each image is an important macroblock; and
a video synopsis synthesizing unit, for generating a video synopsis by synthesizing the important macroblocks of the images according to the distribution of the important macroblocks in each of the images.

2. The system according to claim 1, wherein the decoder unit is used for analyzing video bit streams to obtain video content so as to further obtain specific video compression information thereof for the important macroblock analysis unit to determine if each of the macroblocks in each of the images is an important macroblock, wherein said specific video compression information includes at least one of the following: the number of encoded bits used, motion vectors, encoding types and DCT coefficients.

3. The system according to claim 1, further comprising an image data storage unit for storing the images and video compression information obtained from the decoder unit so as to provide the system with required encoding information for decompressing the compressed video in a non real-time application.

4. The system according to claim 1, wherein the important macroblock analysis unit determines the importance of a macroblock according to the encoding information of the macroblock, wherein the encoding information includes at least one of the following: the number of encoded bits used, motion vectors, encoding types and DCT coefficients.

5. The system according to claim 1, wherein the important macroblock analysis unit determines the importance of an individual image according to the distribution of importance in the images, wherein an important image is defined as an image that has important macroblocks.

6. The system according to claim 1, wherein the video synopsis synthesizing unit synthesizes a video synopsis of a video segment in a particular time interval, wherein said video synopsis comprises all of the important macroblocks in said video segment.

7. The system according to claim 1, further comprising a client interface unit for viewing the video synopsis results, wherein the video synopsis results are displayed on a main window and the original images from which the important macroblocks are originated are displayed on multiple sub-windows, wherein the sub-windows further displays the original images from which overlapped important macroblocks are originated.

8. A method for generating a video synopsis from a compressed video, comprising:
decoding a compressed video to extract decompressed images, wherein the compressed video is formed by compressing a plurality of macroblocks in each image of the original video, wherein each of the plurality of macroblocks has a predetermined macroblock size;
analyzing the encoding information in the compressed video so as to determine if each of the plurality of macroblocks in each of the images is an important macroblock; and
generating a video synopsis by synthesizing the important macroblocks in the images according to the distribution of important macroblocks in each of the images.

9. The method according to claim 8, comprising determining whether each of the macroblocks in each of the images is an important macroblock according to the encoding information of each macroblock, wherein said encoding information includes at least one of the following: the number of encoded bits used, motion vectors, encoding types and DCT coefficients.

10. The method according to claim 8, wherein determining whether each macroblock in an image is an important macroblock further comprises determining if each image is an important image according to the distribution of important macroblocks in said image.

11. The method according to claim 9, wherein determining whether each macroblock in an image is an important macroblock further comprises analyzing the relationship between said image and its adjacent images to determine if each macroblock in an image is an important macroblock.

12. The method according to claim 10, wherein synthesizing the video synopsis further comprises deleting unimportant images based on the importance of each individual image.

13. The method according to claim 8, further comprising generating a video synopsis with overlapping images according to overall important macroblock information and user defined parameters.

14. The method according to claim 8, further comprising a user interface for the user to configure video and display settings.

15. The method according to claim 8, wherein decoding the compressed video comprises decoding important information from the compressed video, said important information comprising at least one of the following: the number of encoded bits used, motion vectors, encoding types and DCT coefficients.

16. The method according to claim 15, further comprising storing the video information and the important information in a storage device.
